(19) United States
(12) Patent Application Publication
(10) Pub. No.: US 2008/0208638 A1
(43) Pub. Date: Aug. 28, 2008

(54) Methods and systems for administration of funds

(76) Inventors: Charles E. Davidson, Clearwater Beach, FL (US); Jay R. Ver Hulst, Clearwater, FL (US)

Correspondence Address: BARTONY & HARE, LLP, 1806 FRICK BUILDING, 437 GRANT STREET, PITTSBURGH, PA, 15219-6101, US

(21) Appl. No.: 12/009,731

(22) Filed: Jan. 22, 2008

Related U.S. Application Data
(60) Provisional application No. 60/881,716, filed on Jan. 20, 2007.

(51) Int. Cl. G06Q 40/00; G06Q 10/00; G06Q 20/00

(52) U.S. Cl. 705/4; 705/35; 705/44; 705/30; 705/36 R

(57) ABSTRACT

A method of administering access to funds in at least one account for which disbursement of funds from the account requires meeting qualifications includes the acts of providing a computer interface via which at least one member can log onto a system; determining if the member is eligible for disbursement of funds; if the member is determined to be eligible, providing a computer interface via which the member can enter information associated with a claim for funds; and applying rules saved in memory of the system to the information associated with the claim to determine if the claim meets the qualifications. A system for administering access to funds in at least one account for which disbursement of funds from the account requires meeting qualifications includes: at least one administrator computer system; at least one memory system in operative connection with the administrator computer system; at least one communication portal in communicative connection with the administrator computer system to provide communication to and from the administrator computer system; at least one list of members eligible members stored in the memory system, at least one interface via which at least one of the members can log onto the administrator computer system upon providing the security information; at least one interface via which the logged member can enter a claim for funds from the logged member's account and information associated with the claim; and at least one set of rules stored in the memory system, the set of rules being applicable to the information associated with a claim submitted by the logged member to determine if the claim is qualified.

### CROSS-REFERENCE TO RELATED APPLICATION

This application claims benefit of U.S. Provisional Patent Application Ser. No. 60,881,716. filed Jan. 20, 2007, the disclosure of which is incorporated herein by reference.

### BACKGROUND OF THE INVENTION

The present invention relates generally to methods and systems for the administration of funds, and, particularly, to methods and systems for the administration of funds for the purpose of reimbursement of qualifying expenses (claims).

For example, the United States Governmental Accounting Standards Board (GASB) has established new standards for Other Post Employment Benefits (OPEB), which are post-employment benefits other than pensions, that will eventually apply to every state, city and county government, as well as to specialized public organizations such as school districts, hospitals, colleges and universities (Applicable Groups). In the past, government employers have reported the cost of retiree heath care and other non-pension benefits on a “pay as you go” basis. The annual cash paid for such benefits has been the annual “pay as you go” expense with no other liabilities or funding requirements shown on such Applicable Group's balance sheet. The new standards, known collectively as GASB 45, have rolling effective dates, based upon the size of the Applicable Group, beginning Dec. 15, 2006.

Under GASB Statement No. 45 or GASB 45, the disclosure of which is incorporated herein by reference, Applicable Groups must account for, and report, the annual cost and liability of OPEB in the same way such groups report pension costs and liabilities. As a result, the annual OPEB costs for most such Applicable Groups will be based on actuarially determined amounts rather than in the “pay-as-you-go” method. In general, GASB 45 requires government entities to recognize the full financial liability of promised (that is, future) retiree health benefits on their books (which, until now, have not been recognized). As the present value of such benefits will be burdensome to many Applicable Groups, GASB 45 has created the need for Applicable Groups to find a different manner in which to provide retiree health benefits and to account for such liabilities.

One manner of providing such benefits is to have the Applicable Groups create health care reimbursement accounts that are funded by employers while the employees are still employed. The accounts are then drawn upon by the employees after retirement (Beneficiaries) to reimburse the retirees for qualified medical expenses. These funds would enjoy the tax advantages of similar reimbursement accounts (Health Reimbursement Accounts or HRAs) under IRS Revenue Rulings 2002-41 and 2002-45.

One of the primary problems in GASB 45 administration is the difficulty and exorbitant cost associated with that administration.

It is thus desirable to develop methods and systems for the administration of funds and, particularly, to develop methods and systems for the administration of funds for the purpose of reimbursement of qualifying expenses.

### SUMMARY OF THE INVENTION

In one aspect, the present invention provides a method of administering access to funds in at least one account for which disbursement of funds from the account requires meeting qualifications. The method can, for example, include the acts of providing a computer interface via which at least one member can log onto a system; determining if the member is eligible for disbursement of funds; if the member is determined to be eligible, providing a computer interface via which the member can enter information associated with a claim for funds; and applying rules saved in memory of the system to the information associated with the claim to determine if the claim meets the qualifications.

The account can, for example, be a reimbursement account for retiree health benefits. The rules can, for example, be based at least in part upon section 213(d) of the Internal Revenue Code of the United States.

The member can, for example, log onto the system via a computer network. The computer network can, for example, include or be in communication with the internet.

In several embodiments of the present invention, if the claim cannot be determined to meet the qualifications upon application of the rules on the basis of the associated information entered by the member, the method can further include requesting further substantiation of the claim from the logged member. The further requested substantiation can include a request for documentation. The documentation can, for example, include a receipt. A substantiation review can include a review by a trained reviewer. The method can further include providing the member with instruction for transmission of substantiating documentation. The member can, for example, upload the documentation, fax the documentation or mail the documentation.

The method can also include requesting a disbursement of funds from an account of the member maintained at an entity (for example, a banking or investment entity or institution) via the system. The method can also further include the entity transferring funds into an account of an administrator of the system (and/or the system account receiving such funds) for disbursement to the member.

The method can further include providing at least one type of accounting report via the system (to, for example, an entity maintaining an account of the member). A plurality of standard accounting reports can be available. Customized accounting reports can also be available wherein an entity or person requesting the report can choose parameters setting forth, for example, data to be included in a report and/or a format of the report.

The method can further include providing the member with choices of investment vehicles/accounts available at or from at least one entity (for example, a financial or investment entity or institution) in which funds can mature while awaiting disbursement. The system can provide tools for managing funds in the accounts at the entity or entities. The system can also provides account values.

The method can also include mirroring or replicating data between two different storage locations. Data can, for example, be mirrored or replicated between memory of at least one investment or financial institution and memory of the system. Eligibility can, for example, be determined based at least in part upon data uploaded to memory of the system from another entity.

In another aspect, the present invention provides a system for administering access to funds in at least one account for which disbursement of funds from the account requires meeting qualifications. The system can include an administrator computer system; at least one memory system in operative connection with the administrator computer system; at least one communication portal in communicative connection with the administrator computer system to provide communication to and from the administrator computer system; at least one list of eligible members stored in the memory system, at least one interface via which at least one of the members can log onto the administrator computer system (for example, upon providing the security information); at least one interface via which the logged member can enter a claim for funds from the logged member's account and information associated with the claim; and at least one set of rules stored in the memory system, the set of rules being applicable to the information associated with a claim submitted by the logged member to determine if the claim is qualified.

As described above, the account can be a reimbursement account for retiree health benefits. Moreover, the rules can, for example, be based at least in part upon section 213(d) of the Internal Revenue Code of the United States

The system can further include a mechanism for communicating a request for disbursement of funds from an account of the logged member. The account can be maintained at a financial or investment entity or institution. The financial or investment entity or institution can, for example, include a computer system in communicative connection with the communication portal.

The communication portal can, for example, be in communicative connection with a computer network. The computer network can include or be in communicative connection with the internet.

The system can further include a system, interface or mechanism for requesting further substantiation of the claim from the member. Substantiation can, for example, be requested if the claim cannot be determined to meet the qualifications upon application of the rules on the basis of the associated information entered by the member. The further requested substantiation can, for example, include a request for documentation. The documentation can, for example, include a receipt. A substantiation review can be performed by a trained reviewer. The member can, for example, be provided with instructions for transmission of substantiating documentation. The mechanism for requesting further substantiation include an interface via which the member can upload the documentation to the system. The member can also be provided with options of faxing the documentation or mailing the documentation.

The system can also include a system or mechanism for communicating a request for disbursement of funds from an account of the member maintained at an entity (for example, a financial or investment entity or institution) via the communication portal. Likewise, the system can further include a system or mechanism whereby the entity transfers funds into an account of an administrator of the system for disbursement to the member.

In several embodiments, the system can also include a report generator to provide at least one type of accounting report via the system. A plurality of standard accounting reports can be available. Customized accounting report can also be available for generation.

The system of the present invention can also include a system, interface or mechanism to provide the member with choices of investment vehicles available at or from at least one entity (for example, a financial or investment entity or institution) in which funds can mature (in one or more accounts) while awaiting disbursement. The system can, for example, provide tools for managing funds in the accounts maintained at the entity or entities. The system provides account values for one or more accounts of the member.

The system can also include a mirror or replicating system to mirror or replicate data between two different storage locations so that the mirrored or replicated data can be stored on the memory system. Data can, for example, be mirrored between memory of at least one investment or financial entity or institution and the memory system. Eligibility can, for example, be determined based at least in part upon data uploaded to memory of the system from another entity.

In still another aspect, the present invention provides a method of administering a plan for post-employment benefits other than pension benefits for an employer participating in the plan, comprising: providing at least one communication link between the employer and a computer controlled system comprising a processor system and a memory system; providing at least one communication link between the computer controlled system and at least one financial intuition maintaining at least one banking account to which funds can be transferred and from which funds can be transferred for payment; providing at least one communications link between the computer controlled system and at least one institution maintaining at least one investment account in which funds can be invested, the at least one account containing invested funds of a plurality of members, each member being a current employee or a former employee of the employer; providing a computer interface via which a member can log on and communicate with the computer controlled system; determining if the member is eligible for disbursement of funds from the investment account via the computer controlled system; if the member is determined to be eligible, providing a computer interface via which the member can enter information associated with a claim for disbursement of funds; and applying rules saved in the memory system of the computer controlled system to the information associated with the claim to determine if the claim meets the qualifications.

The computer controlled system can, for example, determines amounts of funds the employer is to transfer into various accounts and the employer is invoiced according to the determined amounts of funds. In several embodiments, a plurality of investment accounts are provided, and the employer transfers funds to the at least one banking account in response to invoicing generated by the computer controlled system (for example, on the bases of investment elections/instructions of the members). The computer controlled system can then transfer funds transferred by the employer into one or more of the investment accounts in a manner determined at least in part by instructions received from the plurality of members.

The computer controlled system can also effect transfer of disbursement funds determined to meet the qualification from the at least one investment fund to the at least one banking fund. The computer controlled system can then effect transfer of the disbursement funds determined to meet the qualification to the member.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a schematic diagram of one embodiment of a system of the present invention.

FIG. 1B illustrates mirroring of data sets within the system of FIG. 1.

FIG. 2 illustrates determination of employee eligibility to submit claims (for example, under Government Accounting Standards Board Statement No. 45 or GASB 45) based upon data uploads from another entity such as a public entity employer.

FIG. 3A illustrates an embodiment of a display of an Investment Overview menu item.

FIG. 3B illustrates an embodiment of a display of the funds available for investment.

FIG. 4 illustrates an embodiment of a screen display or page setting forth a key for the status of claims, which can be available to all users to help determine the status of a claim (wherein the designation “A”, when associated with “Status”, refers to Approved etc.).

FIG. 5 illustrates an example of a log-in display screen or page with help menus to aid a member in accessing the member's information.

FIG. 6 illustrates an example of a display screen or page wherein the site administrator, plan administrator and/or an investment institution may post memo's to all users, which may be time sensitive information or even permanent communications.

FIG. 7 illustrates a display screen or page of pharmacy claims, itemizing out the “Plan” cost and “Your Cost”, which would be the amount submitted under GASB 45.

FIG. 8A illustrates an embodiment of a display setting forth topic headers, under which there are sub-topics including listings of and/or hyperlinks to specific health care related sites.

FIG. 8B illustrates an example of sub-topics under the Allergy topic of FIG. 8A.

FIG. 8C illustrates specific sites under the sub-topic Allergies/Food.

FIG. 8D illustrates an embodiment of a screen display or page upon which, for example, a plan administrator can set forth certain preferred provider organizations from which a beneficiary can choose medical providers.

FIG. 8E illustrates an embodiment of a screen display or path via which a beneficiary (or member) can be provided with the ability to modify their eligibility and other data.

FIG. 8F illustrates an example of a query display screen or page through which a beneficiary can, for example, view the status of claim processing at any given time or make an inquiry of a customer service representative.

FIG. 8G illustrates an embodiment of a plan document display screen or page in which the entire plan document can be available on-line.

FIG. 8H illustrates a user profile display screen or page via which a beneficiary or other member can customize the site via entry of, for example, passwords, registered e-mail, PINs (personal identification numbers) and/or other user profile information.

FIG. 9 illustrates an embodiment of a Forms display screen or page via which certain forms and external sites which may be necessary from time to time can be accessed by members, which forms the GASB 45 program would recognize certain “life” events as defined under the regulations.

FIG. 10 illustrates an embodiment of a Submit Claim display screen or page via which data for a claim submission can be input into the system.

FIG. 11 illustrates an embodiment of an Add Premium AutoPay display screen or page (which can, for example, be accessed via a Scheduled Payments display screen or page), via which a member can input data into the system to set up a recurring premium payment.

FIG. 12 illustrates an example of a screen display or page that can be displayed to a user during processing of a request to the system.

FIG. 13 illustrates an embodiment of a claim review screen display or page which, for example, illustrates the ease in completing a claim submission, including a scanned image upload tool to, for example, enter a receipt into the system of the present invention.

FIG. 14 illustrates an embodiment of the Scheduled Payments screen display or page and the Add Premium AutoPay subscreen or page.

### DETAILED DESCRIPTION OF THE INVENTION

Several representative embodiments of the present invention are described herein in connection with GASB 45 administration. One skilled in the art appreciates, however, that the systems and method of the present invention are generally applicable to administration of funds in one or more accounts wherein disbursement of funds from the account(s) requires meeting qualifications. Further, several embodiments of the present invention are particularly suitable for use in administration of a system in which integration and/or automation of banking (for example, including payment transactions), investment of funds, claim administration and communication (for example, reporting, noticing etc.) is desirable.

As used herein and in the appended claims, the singular forms “a,” “an”, and “the” include plural references unless the content clearly dictates otherwise. Thus, for example, reference to “a memory” includes a plurality of such memories and equivalents thereof known to those skilled in the art, and so forth, and reference to “the memory” is a reference to one or more such memories and equivalents thereof known to those skilled in the art, and so forth.

The tasks involved in GASB 45 administration include eligibility determination, fund investment, examination of claims to assure compliance with various IRS regulations, payment, reconciliation and reporting. In several embodiments, the present invention provides administration methods and systems that incorporate or include network (for example, the internet or web) technology, designed to perform various tasks (such as those described above) in, for example, a Human Resources Administration (“HRA”) environment. The methods and systems of the present invention are preferably sufficiently flexible to integrate web and traditional communication functions (for example, United States Postal Service (“USPS”) postal functions) in an inexpensive, virtually automated manner. Users can, for example, access the system via high-speed or other internet connectivity. For those users who do not have personal access to the internet, Applicable Groups implementing the present invention can, for example, provide computer, scanner and/or internet connections within their offices or elsewhere for beneficiaries use. For those users not located near a computer provided by a former employer, the beneficiaries can, for example, utilize a public library or other local services. As a last measure, beneficiaries can communicate via telephone and USPS (United States Postal Service) to a claims administrator, where the web-based system resides. Written communication transmitted via scanned documents, faxed documents etc. can undergo optical character recognition for conversion into computer readable data. Definitions for a number of terms used herein are set forth below.

As used herein, the term “plan” refers to the GASB Plan to be administered.

As used herein, the term “client” refer to the employer or employers who employ the members and beneficiaries.

As used herein, the term “employer” refers the entity who employed the member or beneficiary who accumulated funds in accordance to GASB 45.

As used herein, the term “member” refers to an individual who is accumulating funds or has accumulated funds in accordance to GASB 45.

As used herein, the term “beneficiary” refer to individual(s)/members who are retired or otherwise qualified members of the GASB 45 Plan in accordance with the plan's definition of eligibility.

As used herein the term “claim” refers to a submission of healthcare related expenses as defined by section 213(d) of the Internal Revenue Code (IRC). Claims made which are not qualified under this section, are denied claims.

As used herein, the term “plan administrator” refers to the individual(s), typically at the employer, who is responsible for creation of a GASB 45 program and day-to-day management of the plan.

As use herein, the term “claim administrator” refer to the entity who provides the day-to-day administrative work under the direction of the plan administrator. The claim administrator typically has no discretionary authority, and maintains the processing of claims, to include support of an associated web site in accordance with the plan as dictated by the plan administrator.

As use herein, the term “auto-adjudicated claims” refers to claims that qualify for non-substantiation (for example, recurring and co-pay claims). These claims are not required to have a paper receipt. These claims will be automatically moved to a status of issued, not paid.

As used herein, the term “paid claims” refers to a status of claims upon receipt of funding submission. Issued, not paid claims that are moved to this status upon receipt of funding submission.

As used herein, the term “rejected claims” refers to claims that require substantiation which have not received receipts or documentation of proof of payment by the beneficiary.

As used herein, the term “pending claims” refers to claims identified prior to payment that hit business rules edits. An example would be a claim over $500. These claims are to be pended and will not be moved to issued, not paid status until documentation has been received.

As used herein, the term “stale claims” refers to claims that have been pended, but (for example, after a certain period of time) have not received documentation for substantiation.

In several embodiments, the present invention provides intelligent systems and methods to users thereof through various processes including, for example, choosing available investment vehicles for their members/beneficiaries, investment selection by the members/beneficiaries, tracking of investments, an intelligent auto-adjudication claims processing function, and associated reporting and tracking of all transactions. Unlike existing tools in the industry, the present invention provides the first systems and methods to, among other functions, manage investments, execute eligibility, perform auto-adjudication, distribute communications (for example, carry out reporting) and/or synchronize with financial institutions using an intelligent automated infrastructure. The systems and methods of the present invention may operate in a real-time environment, or in a batch environment. In both cases, an intelligent synchronization engine can manage all transactions.

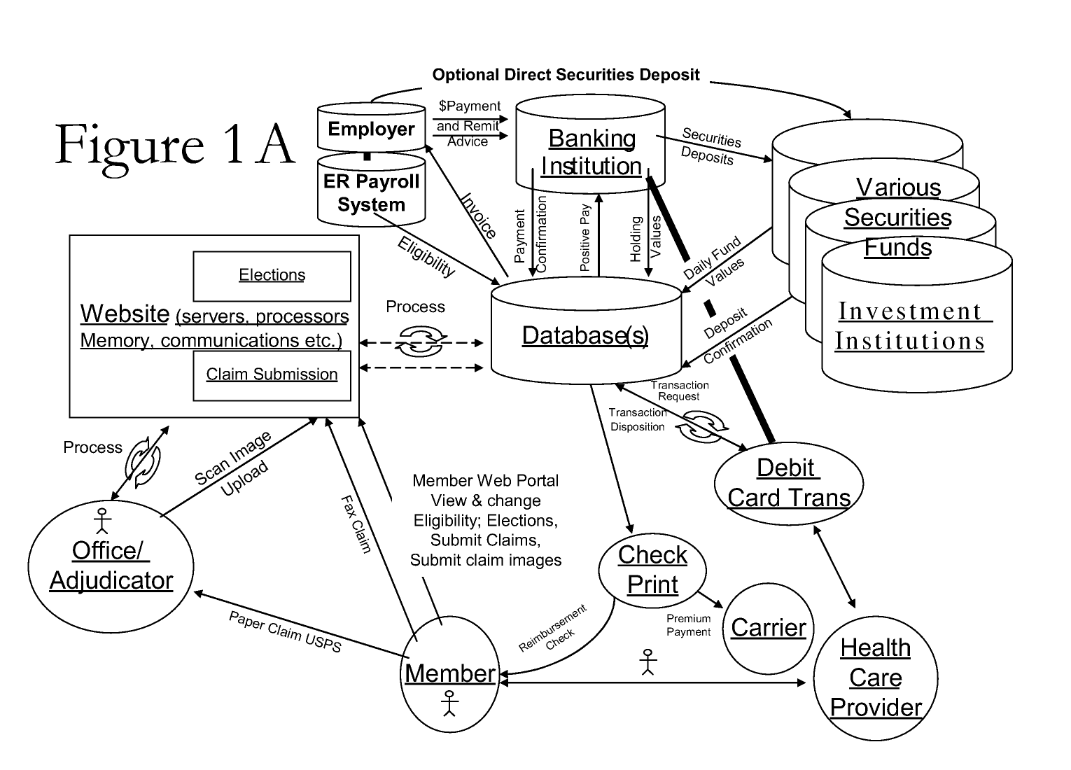

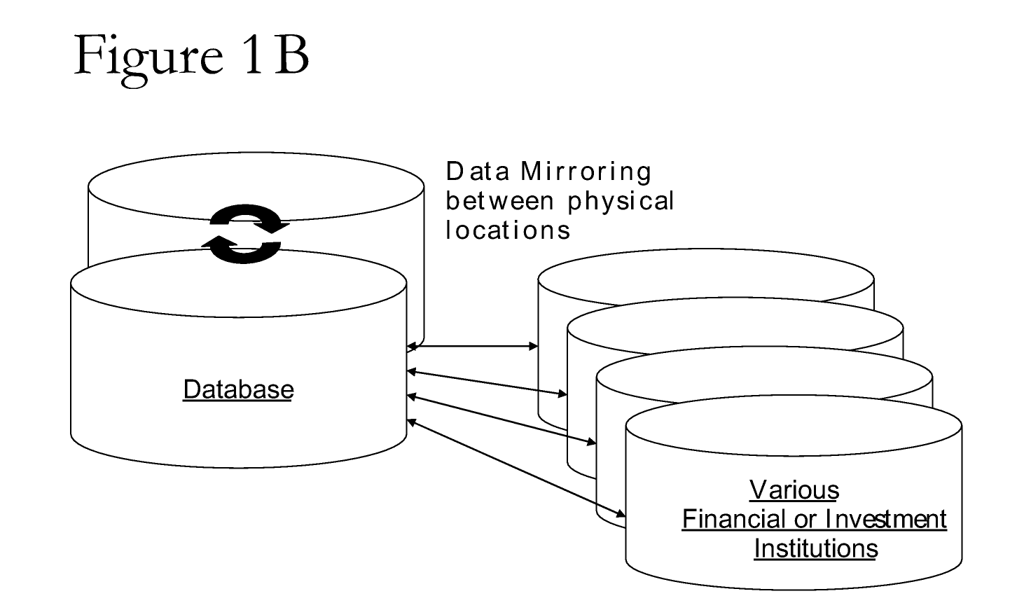

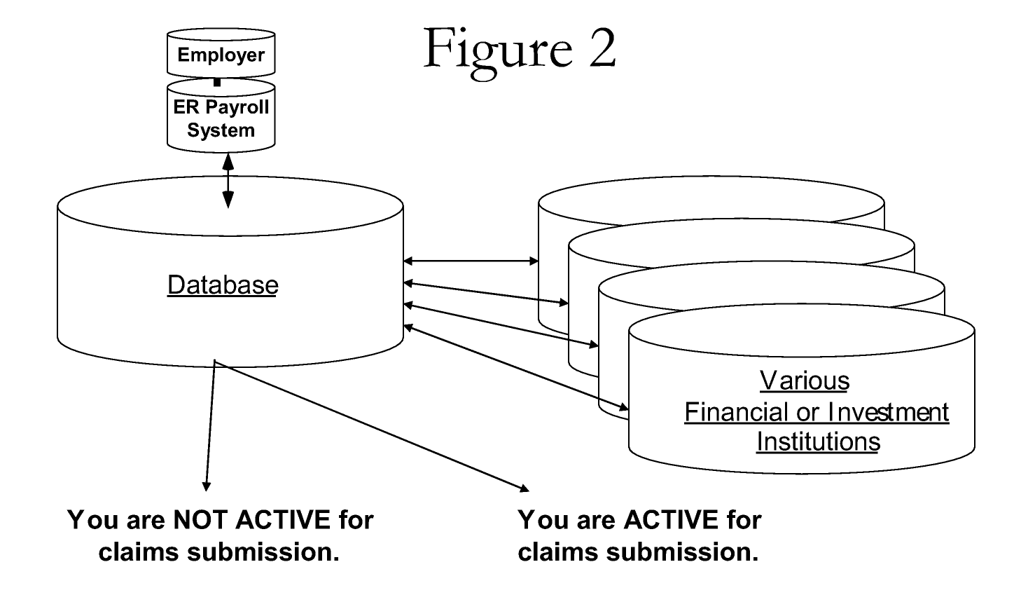

FIG. 1A illustrates a schematic representation of system workflow and communications in one embodiment of a computer implemented system of the present invention. In the illustrated embodiment, the system includes servers, processor systems, computer memory systems and communications systems as known in the art to effect communication and control of various aspects of the system as described herein. As illustrated in FIG. 1A through 2, the maintenance of “mirrored” data sets or databases can be accomplished via standard industry technology as known in the computer arts.

In several representative embodiments, the process embodied in the methods and system of the present invention includes distinct process flows including, for example: (1) mirrored data storage, (2) fund investment and management, (3) claims submission and processing/adjudication (for example, via a website portal); and (4) accounting services including, for example, fund requests, check instrument disbursement and reporting.

The systems and methods of the present invention have the ability to adapt to many different investment institutions. In certain cases, an investment institution can be the record keeper for all investments, offering options for investment using the technology and communication interfaces of the investment institution. The methods and systems of the present invention can link to and coordinate with, for example, the web services of the investment institutions for this purpose.

The methods and systems of the present invention also have the ability to provide investment management services, including, but not limited to, issuing purchase and sell orders to various investment institutions, reconciliation of account values, transference of funds from one investment vehicle to another, and other investment management services as known in the investment arts.

Setting up the manner in which the investment process operates within the systems of the present invention can, for example, be effected via a simple “point and click”, menu-driven methodology upon providing the associated setup choices. Set up can, for example, be performed by the Administrator of the system/site. In several embodiments, there are four levels of management of the system/site. The basic global settings are set at the “System/Site Administrator” level. Virtually all set-up parameters at this level and subsequent levels may be adjusted with the proper security. The next level of management (having correspondingly less access to set parameters) is the “Plan Administrator” level. Below the Plan Administrator level is the “Employer” level. The lowest level of control is the “Member” level.

The methods and systems (sometime referred to collectively herein as either systems or methods) of the present invention provide sufficient flexibility to support many different business relationships.

In the case where a system of the present invention manages funds, communications with the various investment institutions about investment choices can, for example, be communicated via encrypted file transfers. Depending on the investment, those files can be in “near real time” throughout the day, or, in the case where the investment allows a direct link via, for example, web services, in “real time”.

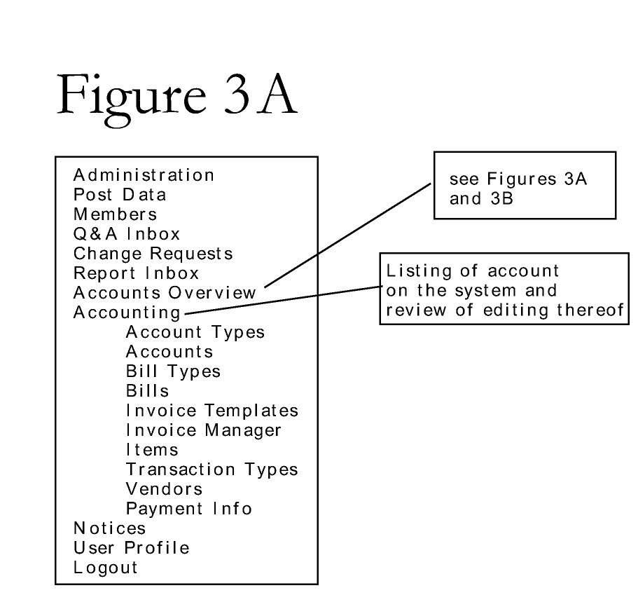

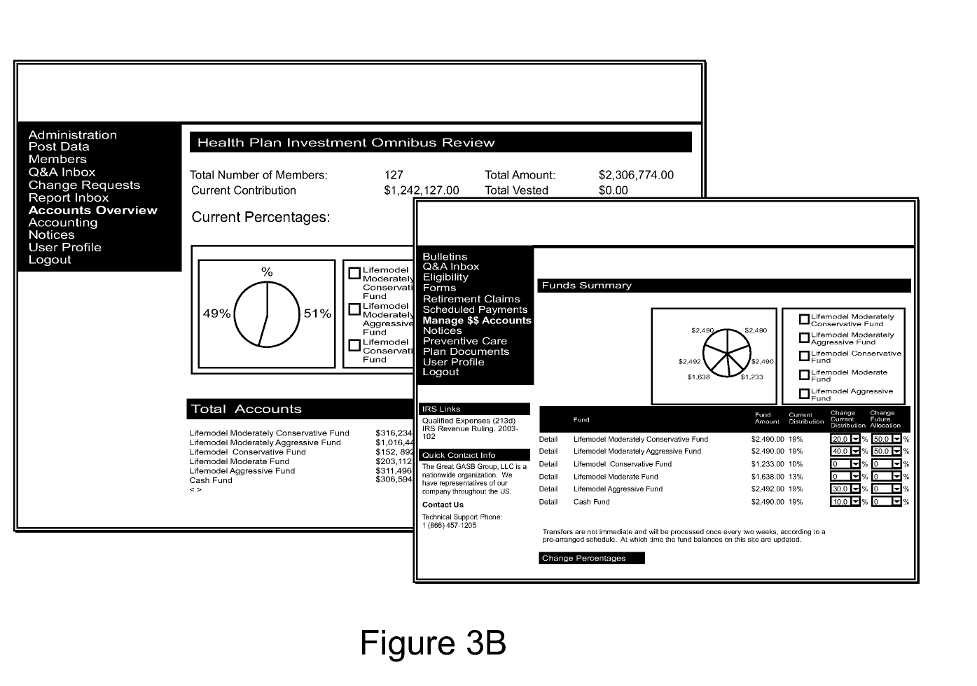

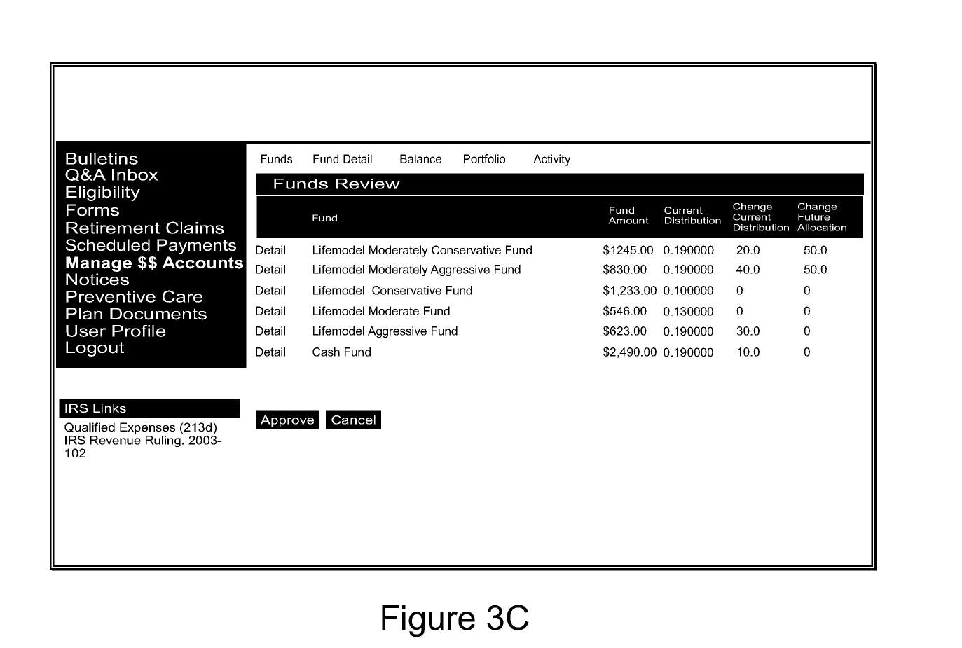

FIG. 3A illustrates an embodiment of a menu for GASB administration for a GASB plan of a client. Nested submenus can be provided under each expandable menu item as known in the computer arts. Administrating a plan for a client can involve administration for a single employer or for a group of employers. Under the Accounting menu item, a listing of all accounts for the plan/client can be listed, whether the accounts are checking accounts, debit card accounts or securities investment accounts for fund contribution, etc. Review and/or editing of the listed items can be enabled through associated displays. All accounts can, for example, be linked so that file transfers, fund transfers and associated notices move in accordance with the desires of the client and in accordance with the plan documents of the client, as filed. An Accounting/Accounting Types menu item can provide a list of account types available on the system (for example, bank accounts, premium accounts, contribution accounts, administration fee accounts, fund contribution accounts, fixed expense accounts, additional fee accounts etc.).

As described above, health care reimbursement accounts can, for example, be created that are funded by employers while the members/employees are still employed. The accounts are then drawn upon by qualified members as beneficiaries after, for example, retirement to reimburse the retirees for qualified medical expenses. As illustrated in FIG. 1A, a database of the system of the present invention can store information regarding the health retirement accounts and invoice an employer according to the stored information for contribution. Typically, an employer will provide a number of investment vehicles (for example, securities funds) from which an employee can choose one or more for investment of funds contributed to the health retirement account. The employer can be invoiced for various invoice items, such as fixed fees for administration, variable fees for administration, fixed contributions, variable contributions, or premiums to insure fund balances. In create a deposit invoice for the employer, the system of the present invention can, for example, settle all vesting rules and contribution levels for each employee.

An Accounting/Invoice Templates menu item (see FIG. 3) can, for example, set forth various templates (for example, for paper or electronic communications such as reports, statements to members or retirees, or reports/statements to a vendor) which can be established and linked to an account. Multiple templates can be made available for each client and account type should the client, for example, have different requirements for different employee/retiree members as are result of, for example, union agreements, state law or other requirements by member.

Invoices can, for example, differ by division, group or office within the employer/client (for example, an auditor office versus an engineering office). The client can, for example, deposit for employees of different divisions at different rates. The client can also use different securities firms/investment institutions for different divisions. Moreover, the client can, for example, pay to a holding account established as part of the system of the present invention for one or more divisions and pay directly to a securities firm or fund for one ore more other divisions.

As described above, upon invoicing for, for example, a fund contribution, an employer can pay into a holding account (for example, by division) of the system of the present invention, for which the funds can, for example, be appropriately transferred, for example, into a securities fund. Alternatively, in the case of an invoice for a fund contribution, the employer can pay directly to a securities fund/firm (for example, by division). An Invoice Manager menu item can be provided to enable review of invoices and payment thereof.

Through an Accounting/Vendors menu item, various bank and investment firms can identified and, for example, associated to each division of the employer An Accounting/Payment Info menu item can be used for each banking institution and investment institution or firm to set forth business rules, account numbers, routing information and encryption codes which are stored so that the system of the present invention can communicate with such institutions and automatically move funds as needed and without (or with minimal) manual intervention.

A Notices menu item provides the ability to review and/or edit system notices that are automatically sent when certain occurrences are present, such as an email to notice a transfer was received or sent.

FIG. 3B illustrates an embodiment of a display associated with an Investment Overview menu item. Information provided can, for example, include all balances within each security, the percent of the total associated with each security, and the current and future account investment percentage. The investment mix can be changed, and such a change can be noticed upon completion of an associated trade or trades. FIG. 3C illustrates an embodiment of a display of the manner in which funds available for investment are chosen (for the employer and for employees/retirees). The election can, for example, be performed by the Plan Administrator. The systems of the present invention can operate as a sub-accounting system wherein the securities/investment institution and the banking institution do not know any individual's actual balances, and wherein all balances are held in omni-bus accounts. The system provides communication with the client/employers, current employees and/or retirees, for example, via one or more network or web portals and/or by paper statements during the time of accumulation of funds, and during the time of disbursement of funds (for example, after retirement) so that, at all times, the status of all funds is available for review and accounted. The system includes built-in redundancies and balancing methodologies so that the system will be in balance at all times.

In the case of a claim, funds can, for example, be processed using an online presence (that is, for example, via an internet web interface or web portal). The intelligent engine processing architecture of the present invention minimizes and, in most cases, eliminates manual, paper-based intervention associated with claim payments from this type of account. The intelligent engine processing architecture is a rule-base system that provides substantial depth and flexibility.

In one embodiment, the methods and systems of the present invention provide for the administration of funds collected for the purpose of reimbursement of qualifying expenses as incurred under section 213(d) of the Internal Revenue Code (IRC) (the disclosure of which is incorporated herein by reference) using intelligent rule sets and algorithms and identify allowable and disallowed medical expenses. See also Internal Revenue Service Publication 502, the disclosure of which is incorporated herein by reference. The methods and systems of the present invention can, for example, enable electronic processing of, make payment of, and provide a system for retrospective audit of appropriate claims as required by IRS regulations.

The methods and systems of the present invention thus manage the reimbursement process using intelligent, computer implemented rule sets developed in accordance with applicable laws and with business acumen and knowledge. Web interface technologies are also provided to assist adjudication of reimbursements. The methods and processes of the present invention, for example, recognize retirement, death, disability and any other events that make funds in one or more investment accounts available immediately to the beneficiary and/or to the beneficiary's named beneficiaries or survivors.

As discussed above, in several embodiments, the systems of the present invention synchronize between financial institutions investment selection, values, disbursements and other related management of funds. Identification of non-eligible employees and eligible beneficiaries can, for example, be accomplished via processing of data transferred into the database(s) of the system of the present invention. For example, the system of the present invention can communicate with to the employer's payroll system as illustrated in FIG. 1A to access and/or mirror applicable data and to determine eligibility based on eligibility algorithms applied to such data. Non-eligible members (that is, those who are accumulating funds but are not yet able to claim benefits) will not have access to the claims submission and processing/adjudication section of the claims administrator's site described herein.

Once a beneficiary is eligible to submit claims for reimbursement as determined by associated 213d IRC qualifications (which include, but are not limited to, retirement, death, or disability), the beneficiary may submit a claim by logging into the system of the present invention using, for example, a login and password as known in the computer arts.

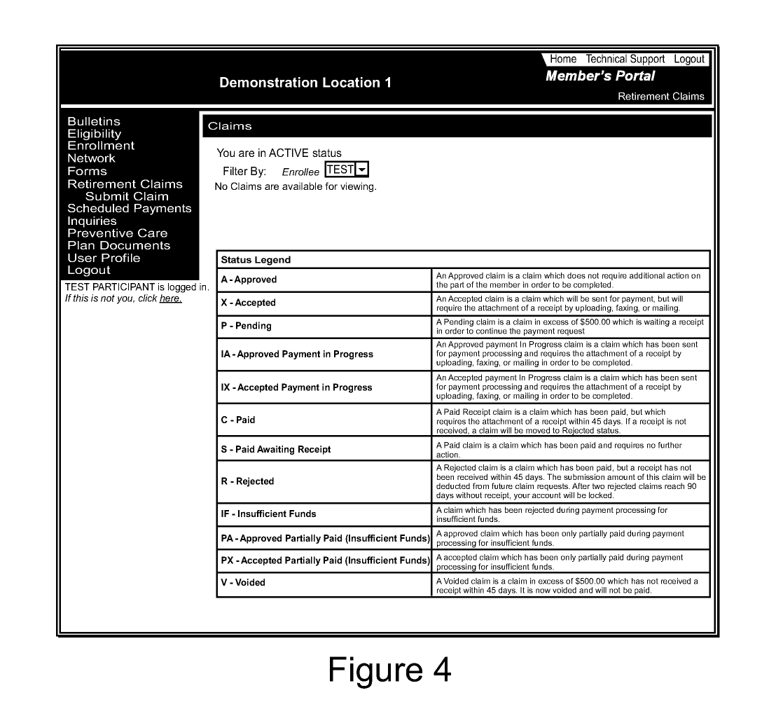

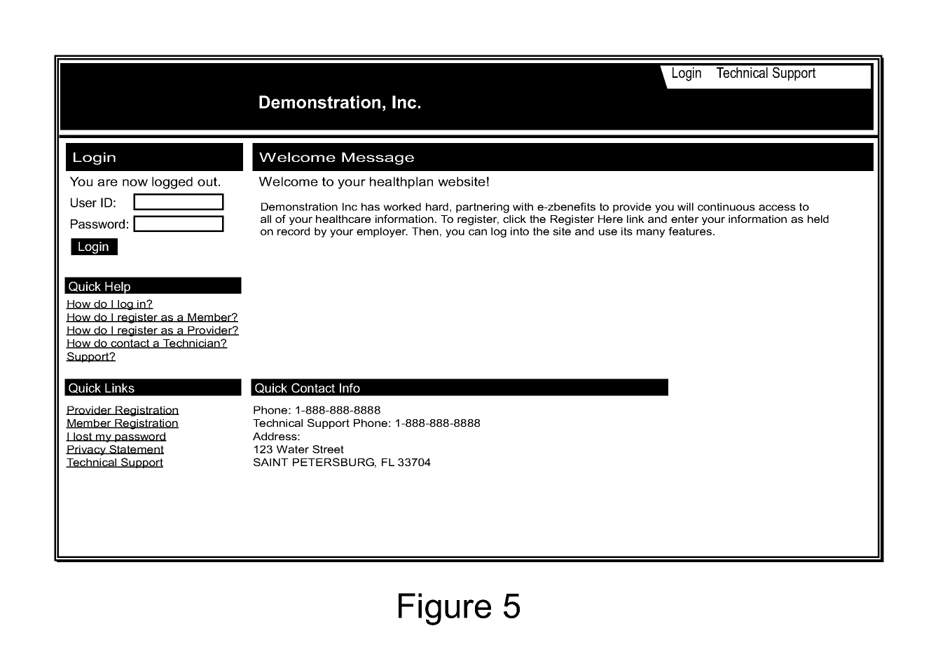

As illustrated in FIG. 4, after successful log-in by an eligible beneficiaries (“Test Participant” in FIG. 4), the beneficiary is, for example, presented with a navigation menu which includes, but is not limited to, access that allow submission for claim reimbursement, communication with claim customer support, set-up of a recurring payment, review of status of claims, and investment fund selection. Examples of a log-in/web portal page and a welcome/navigation menu page are provided in FIG. 5.

The systems and methods of the present invention can, for example, enable various beneficiaries who may want the site to work differently for their needs than for the needs of other beneficiaries to adapt the site to their requirements. For example, in several embodiments, the beneficiary may set-up certain tasks for the methods and systems of the present invention to do for them, such as e-mail (to a registered e-mail address) notification when certain events occur (for example, processing of claims, investment value notifications, and customer service responses). For security (for example, under the Health Insurance Portability and Accountability Act or HIPAA), the site preferably maintains in confidentiality all confidential information. In that regard, notifications can, for example, be generic in nature, and only notify that an event has occurred. Log-in links can be provided in an e-mail notification for ease of the beneficiary to log-in for further detail.

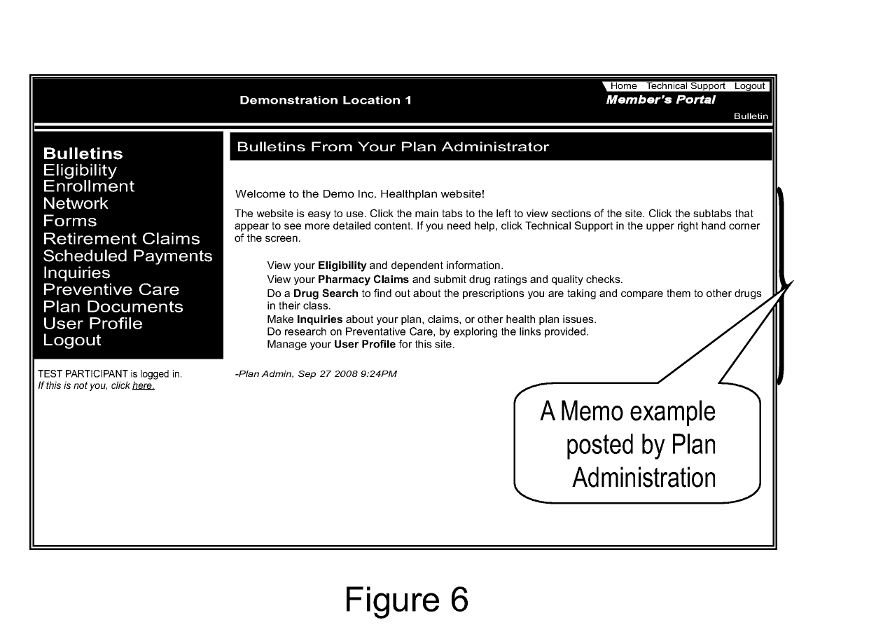

A number of other beneficiary tools are described in connection with FIGS. 6 through 8H. In several embodiments, a bulletin board tool or Bulletins menu item as illustrated in FIG. 6 is provided that may be used by plan administrators to customize the look and feel of member landing pages. Plan administrators can, for example, use this tool to communicate important information to members.

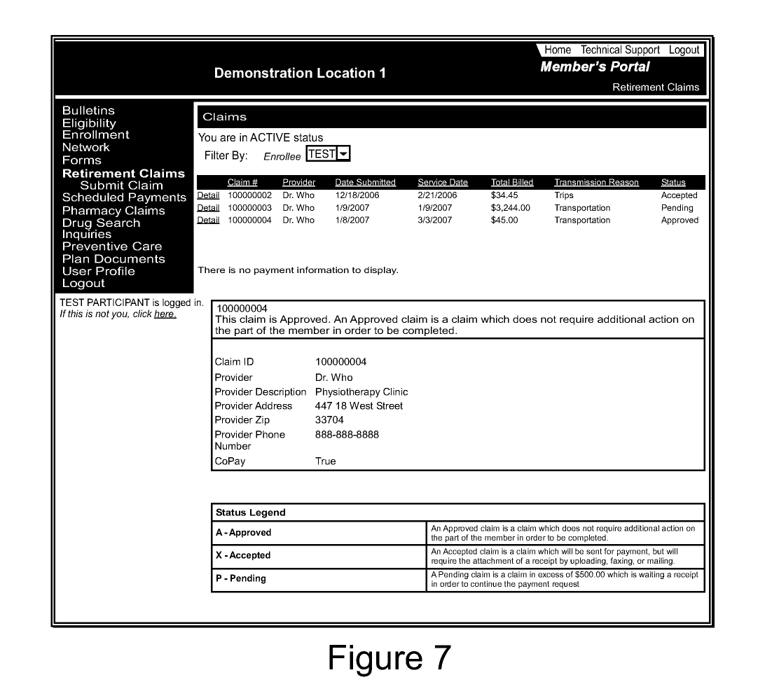

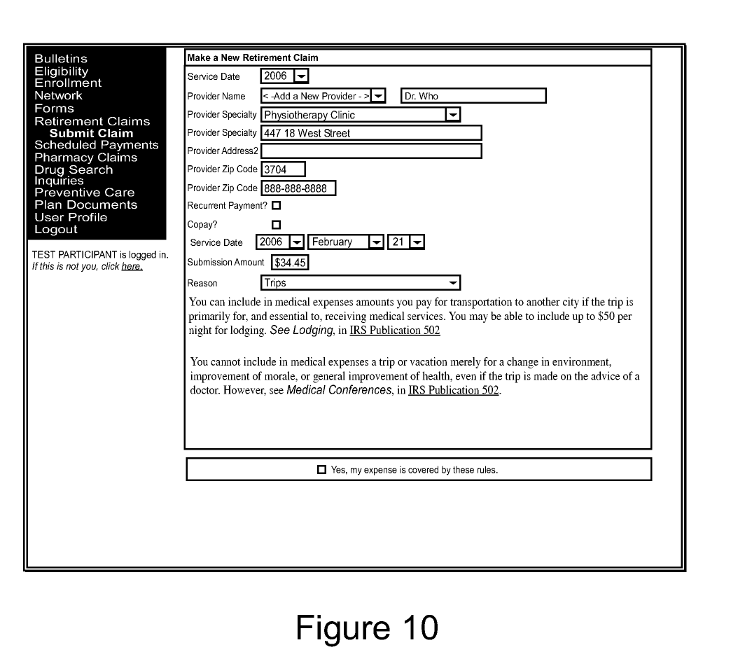

FIG. 7 illustrates an embodiment of a Retirement Claims menu item which sets forth the status of the member and lists various claims of the member and information regarding such claims, including the status thereof. A Submit Claims submenu item enables submission of a claim by a member as illustrated in FIG. 10 discussed below.

Pharmacy claims can, for example, be loaded into the system through data imports received from external payers such a insurance companies. Members can be provided with the ability to view their claims as illustrated in FIG. 7. They can also be provided with the ability to rate the drugs and to review them. This data is saved and is reportable.

Medical, Dental, and Vision claims can, for example, be loaded into the system through data imports received from external payers. Once again, members may then view their claims online.

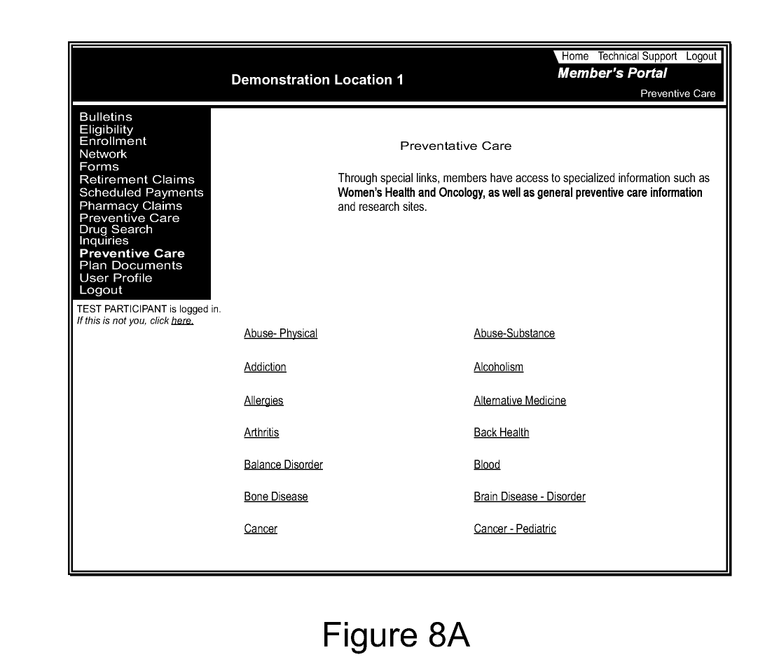

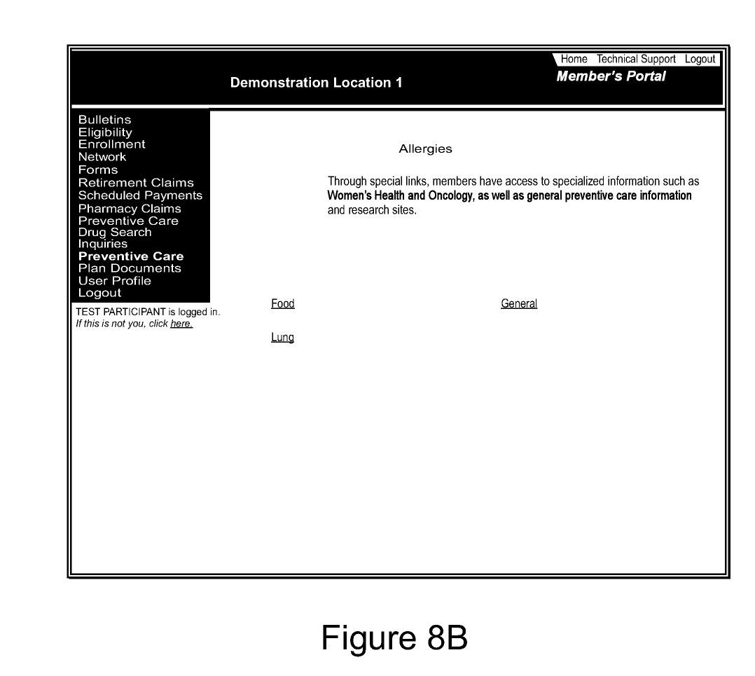

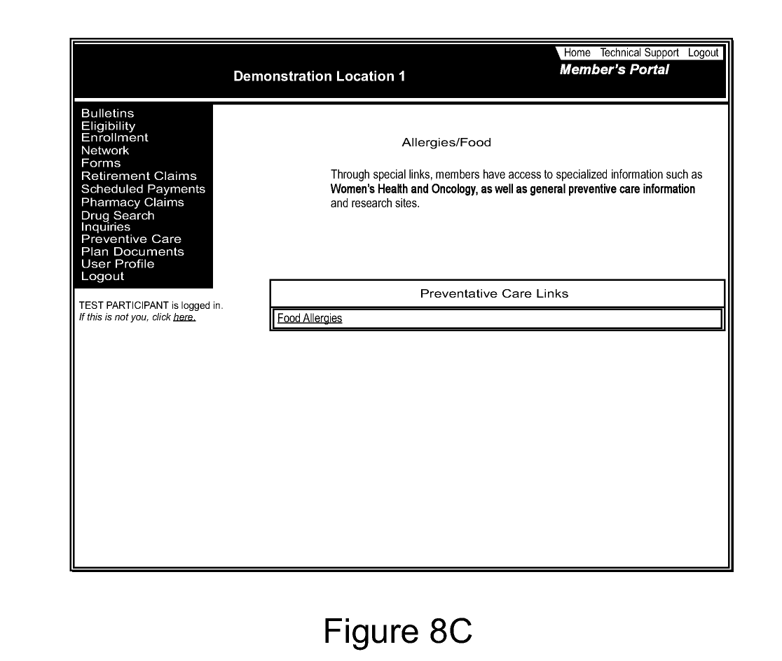

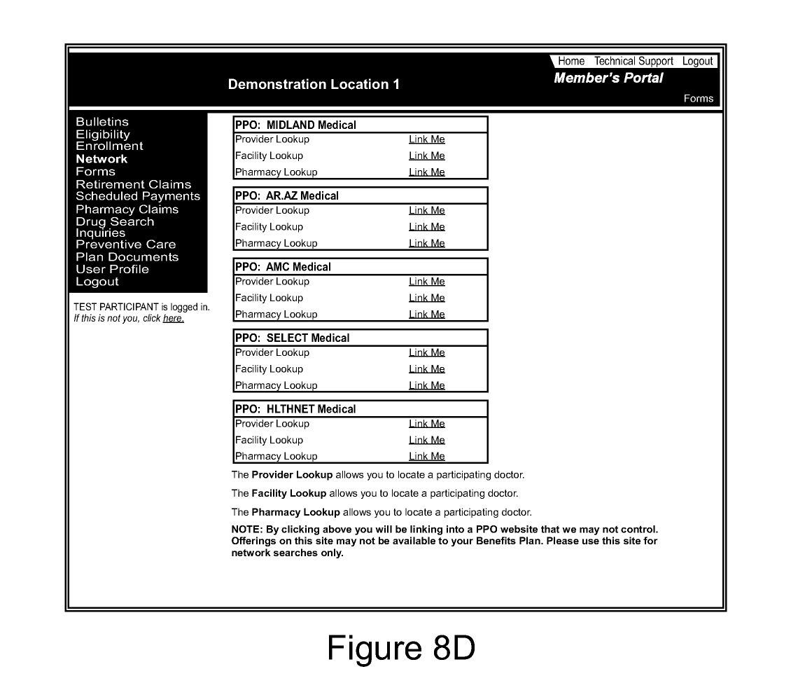

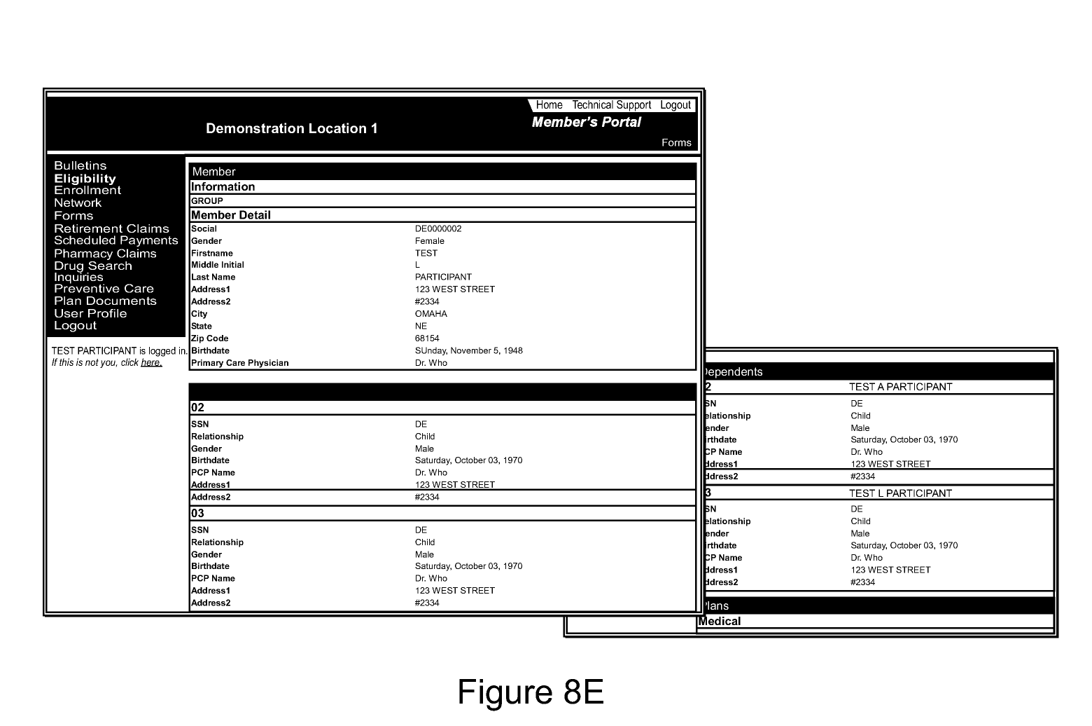

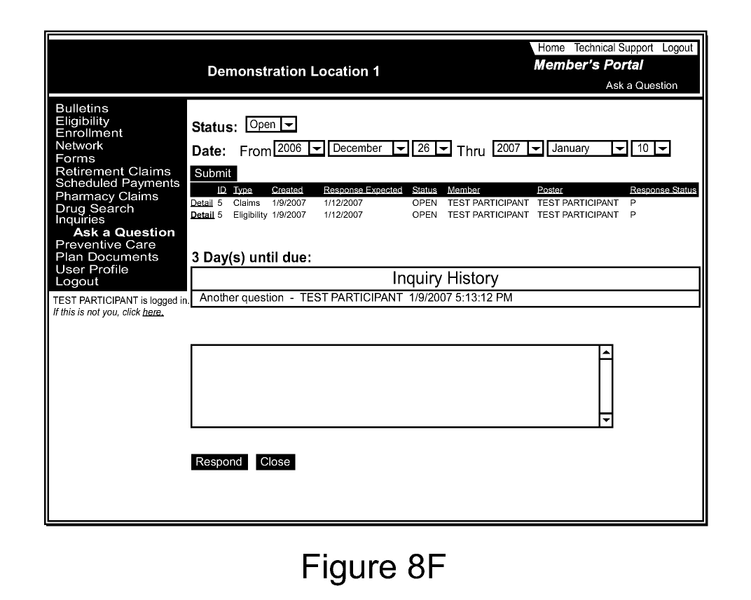

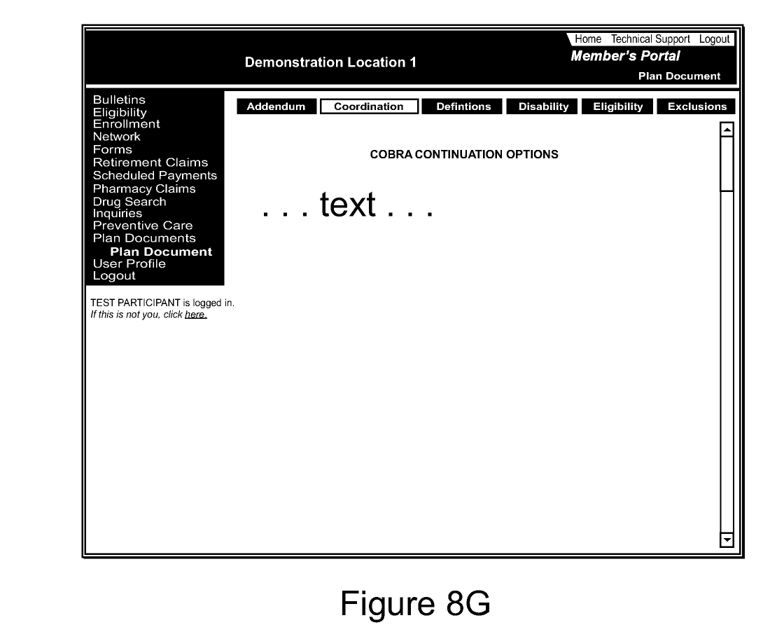

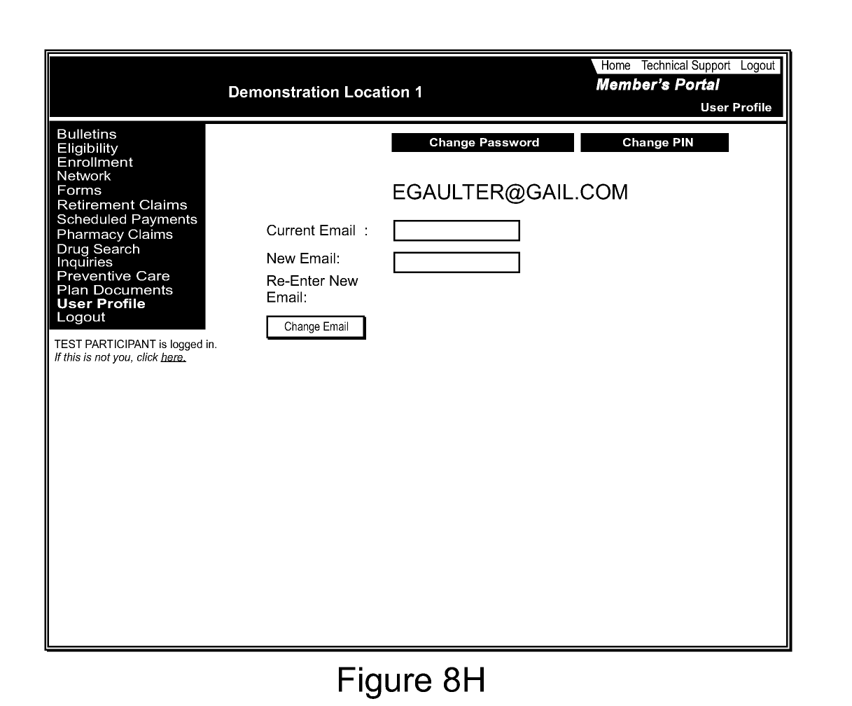

Preventative Care links can, for example, include a collection of categorized external health care, preventative care, and medical links (which can, for example, be collected and tested periodically) as illustrated in FIG. 8A. Members can be provided access to such links to, for example, research medical issues. This tool can enhance the “ease of use” of the site, giving the member the ability to research various diseases, illnesses and wellness topics at the member's leisure. For example, FIG. 8B illustrates an example of sub-topics under the Allergy topic, while FIG. 8C illustrates specific site links under the sub-topic Allergies/Food.

FIG. 8D illustrates an embodiment of a Network menu item and associated screen display or page upon which, for example, a plan administrator can provide certain preferred provider organizations from which the beneficiary can choose medical providers. These medical providers can, for example, provide a discount for services provided. Providers in various network(s) can be easily identified.

Eligibility data can also be accessible online via an Eligibility menu item as illustrated in FIG. 8E. If the system is set up accordingly, the enrollment system will allow members and plan administrators to change this information. If not set up in this manner, eligibility data can be loaded from a partner database as described above. FIG. 8E illustrates an embodiment of a screen display or path via which the beneficiary (member) can be provided with the ability to, for example, add/delete/modify their eligibility or other associated data. The system can, for example, include algorithms or wizards to assist the beneficiary through the process of determining appropriate selections. In most cases, the tool illustrated in FIG. 8E will be used in updating, for example, address information.

FIG. 8F illustrates an example of a query display screen or page through which a beneficiary can, for example, view the status of claim processing at any given time. In addition, the beneficiary may ask questions to customer services by clicking on the claim, and selecting the inquiry tab. A response manager can, for example, allow direct, secure communication between customer service representatives.

Plan documents can, for example, be uploaded and viewed by members and plan administrators. FIG. 8G illustrates an embodiment of a plan document display screen or page in which the entire plan document can be made available on-line. The plan document can, for example, be made available in html to assure quick display. The Plan Document can outline, for example, all the plan rules, such as eligibility, what a claim is, payment process, vesting, etc. The system can, for example, include an administrative tool to upload or apply a MICROSOFT WORD® document (and/or other document formats) to the site, automatically parsing out headings (which are turned into tabs) and converting text to html.

To activate the document upload tool, one can, for example, select the WORD document (and/or other document format) to upload for the particular employer client, make the appropriate selections, and then upload into HTML. Through use of such a tool, the pages are not only separated by topic tabs, but load extremely fast, even when using a dial-up connection. This tool provides substantial utility. For example, PDF documents and other document formats on web sites can require substantial time to download by the Members, and can also be cumbersome to search (particularly if the Member uses a dial-up connection).

A Drug Search utility can, for example, allow members to search for drugs, read instructional leaflets including dosing and warnings, and find comparative drugs. If formularies are setup on the system, it will also indicate the drugs that are included in the member's formulary.

Furthermore, all users can manage their User Profile online including, for example, changing their email address, PIN, and password as illustrated in FIG. 8H.

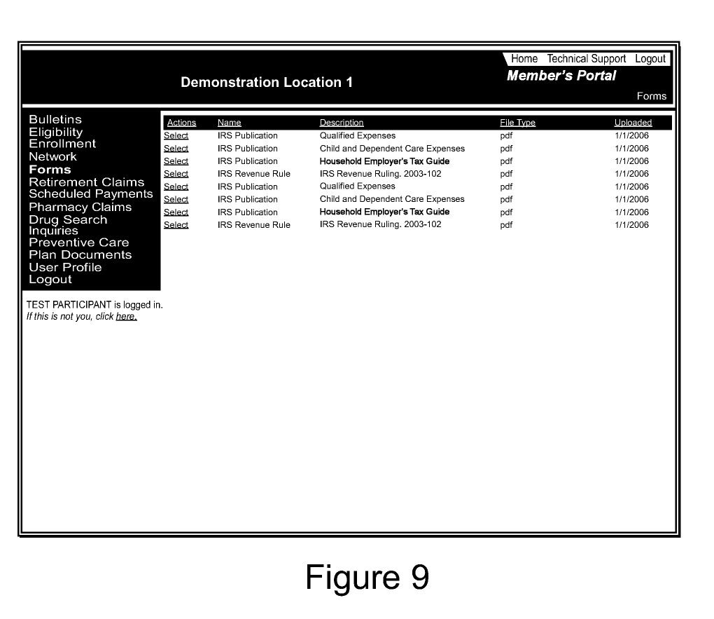

FIG. 9 illustrates an embodiment of a retirement claims web page which links Beneficiaries to other retirement sites that may be included as part of their benefit with their pre-retirement employer(s). The beneficiaries can, for example, be provided with multiple sites to utilize for multiple retirement programs in which they participate (for example, 401(k) or other retirement vehicles). Any member may customize or personalize the system of the present invention to allow the member to access these sites, providing a centralize access point. Site links to certain forms can also be provided. Such forms can, for example, be used for matters that cannot be resolved on-line. An example of such a matter would include obtaining a certified custodial form or notice of death in which the GASB 45 program would recognize certain “life” events as defined under the regulations.

An embodiment of a claims submission web page, which is activated by choosing a “Submit Claim” sub-link or submenu item under the Retirement Claims menu item, is illustrated in FIG. 10. As the beneficiary completes the required fields, depending upon the information/answers submitted, the system can set forth further questions for the beneficiary to complete. Upon completion of all questions required to be answered, the system can, for example, either automatically adjudicate the claim or pend the claim for documentation.

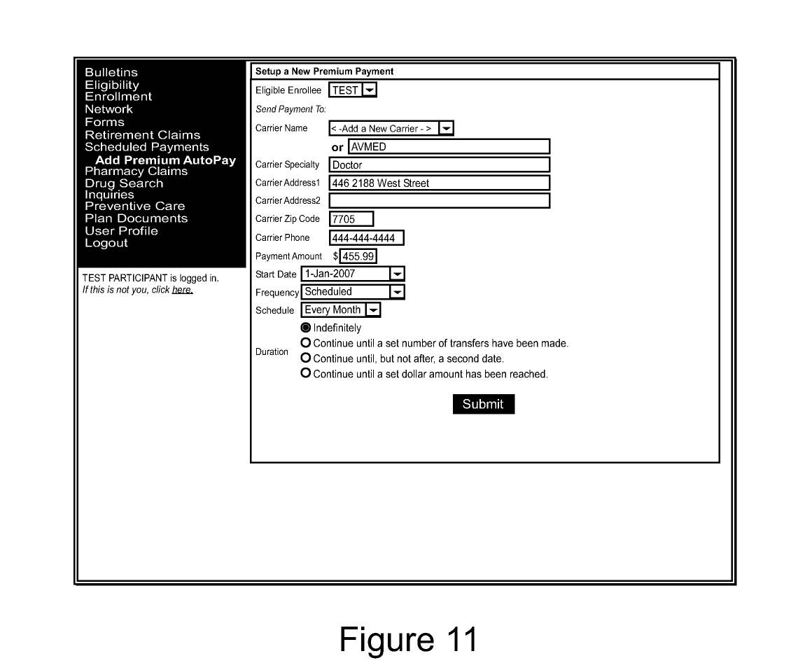

FIG. 11 illustrates an embodiment of a web page adapted to set up a recurring premium payment. This page is, for example, accessible via an “Add Premium AutoPay” submenu item under the “Scheduled Payments” menu item. Many different types of premium payments may be supported under GASB 45, including, for example, Long Term Care. A beneficiary may set up re-occurring premium payments within the system of the present invention to support those payments. The beneficiary can, for example, be provided with a full accounting of historical payments and with the ability to alter payment amounts, addresses for future payments etc. Premium payments preferably take precedent over claim payments so that premiums do not lapse. If sufficient funds are not available to provide premium payments, the site can notify the beneficiary in advance.

As discussed above, business rules have been developed for use in connection with the methods and systems of the present invention to quantify and expedite a substantially or completely “paperless” transaction that decreases turnaround time for adjudication. Several such business rules are summarized in Appendix A hereof. Several such business rules and the processing thereof are also described in the representative Examples set forth below.

In some cases, claims can be “auto adjudicated” in real time upon input of data by the beneficiary based on intelligent rule sets and business logic as discussed above (that is, via the knowledge base resources of the present invention, and without human intervention other than data input by the beneficiary). In other cases, “wizard-type” step-by-step instructions can be supplied to the claim-submitting, qualified beneficiary to facilitate claims reimbursement and keep administrative cost low.

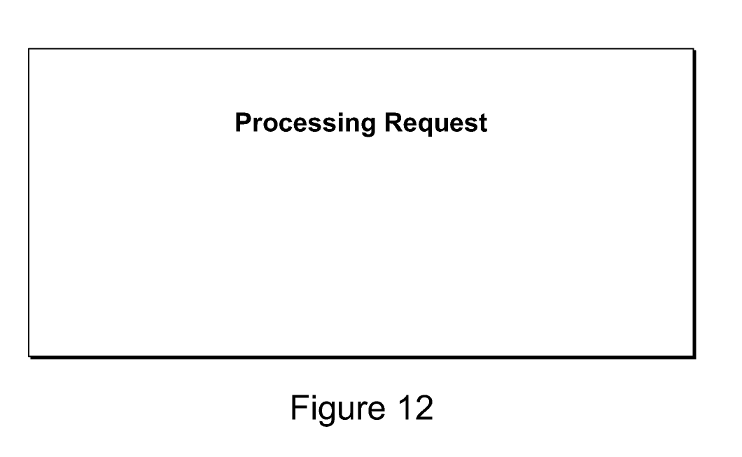

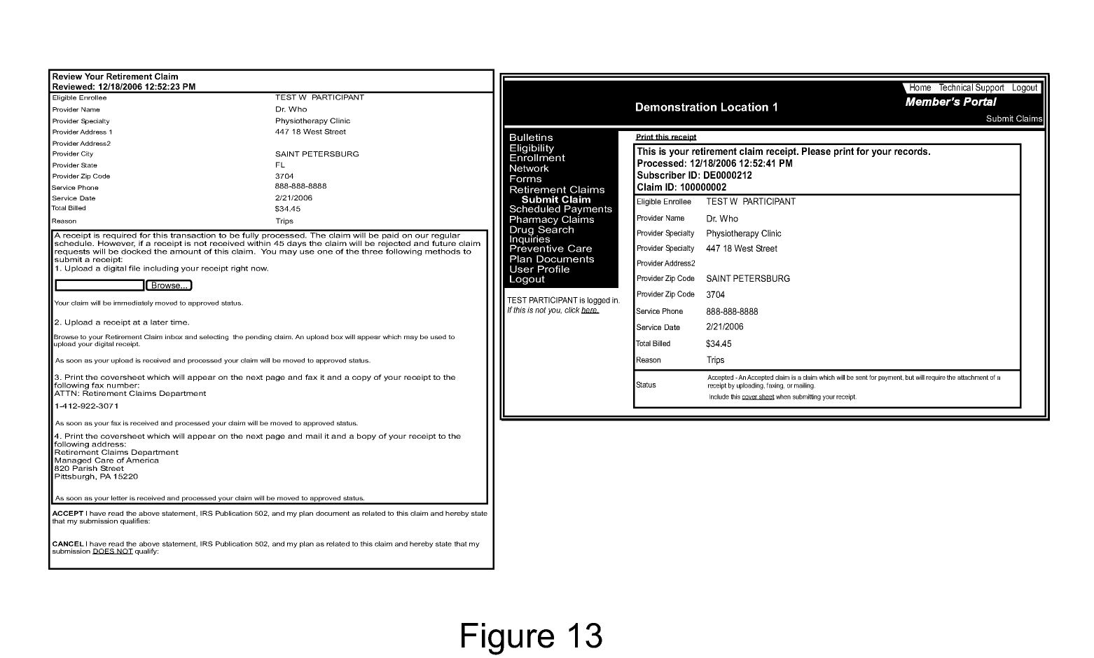

As illustrated, for example, in FIGS. 12 and 13, once the claim has been submitted for adjudication, the claim is either auto-adjudicated online, or the beneficiary is required to substantiate the claim with documentation. Several methods of document delivery or transmission have been developed for use by the beneficiary in connection with the systems of the present invention to transmit supporting documents (when required) as part of the claims submission process. Such methods include faxing, localized scan and upload into the processing engine, and regular mail. Claims faxed and/or scanned that have met the auto adjudication rules and have passed all edits are collected and posted into a pending claims file. This file is supplemented with each successive approval. Claims that are mailed via USPS can, for example, be scanned by the claims administrator and auto-adjudicated by the system of the present invention once loaded by the claims administrator (provided such claims pass all edits and business rules).

Once a claim file meets all business rules edits, it is appended to the pending claim payment file and held for automated fund transfer into the disbursement account. Subsequently, an electronic transfer (for example, to a debit card provided to the eligible beneficiary) or check production to the recipient of funds can be effected.

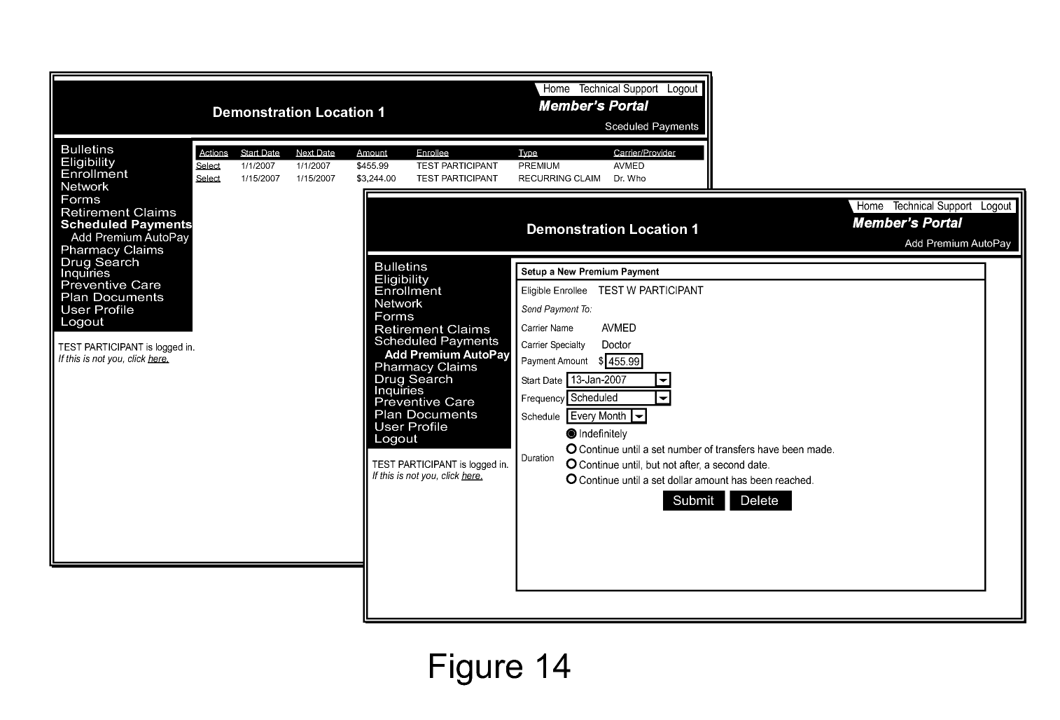

An exception arises in the case of recurring premium payments (which can be created as illustrated in FIG. 14), which take precedence over any outstanding claims so as not to interrupt coverage. In the case of recurring premium payments, fund transfers or check instruments are submitted directly to the insurance company providing coverage.

At this point the claim submission, processing and payment cycle is complete. All payments are moved to paid status as appropriate. Partial payments are allowed, so it should be noted that a claim might be partially funded. When this is the case, that part of the claim that is left unpaid can be considered pended and remains in pended status until the next payment cycle if funds are available.

Another tool or process includes the ability to query online databases and create and customize required reporting by, for example, the plan administrator, the beneficiary/member or an investment institution. Examples of this type of reporting can, for example, include a standard check register, a stale dated check report, a paid claims report, a pended claims report or a claims aging report. These types of reports can, for example, be variable and customizable by such users of the present invention using methods known in the art.

In addition to electronic transfer of reimbursement funds to a debit card provided to an eligible beneficiary as described above, debit cards associated with the systems of the present invention can also be used to transfer money corresponding to a qualified expense directly to a health care provider as, for example, illustrated in FIG. 1A. Upon presentation of the debit card to a health care provider by the beneficiary to pay for goods and/or services, a determination is made by the system of the present invention if the expense is qualified (for example, by identification of the provider, the goods, the services etc. using identifiers/coding as known in the computer arts). If the expenses is determined to be qualified, the transaction is approved and the funds are transferred to the health care provider. In the case of electronic transfer of funds corresponding to a claim for reimbursement of a qualified expense to an account associated with the debit card as described above, the eligible beneficiary is able to use the debit card to access the reimbursed funds for any purpose.

### EXAMPLES

### Example 1

### Requires Receipt and Account Underfunded

In this example, a member logs into the system and submits a claim in the amount of $501 to her physician for a vision correction surgery. The system saves the physician information attached to this member. As this claim is greater than $500, the claim is placed in pending status awaiting a receipt. The member chooses to the scan the receipt and attaches it to the claim. Upon transmission of an acceptable receipt, the claim moves into approved status and awaits the next scheduled communication with the banking institution (in a system operating in a batch manner). The claim is sent to the banking institution for approval of payment. In this case, the member only has $300 available in her account. The banking institution approves her payment in the amount of $300 and wire transfers the funds to an account of the administrator of the system of the present invention. The administrator/system receives the associated approval file from the banking institution. A payment in the amount of $300 is attached to the claim. The system writes, and sends a $300 check (or electronically transfers funds, for example, to a provided debit card). The claim moves into partially paid status. The administrator of the system/system will continue to send a request to the banking institution for the remainder payment for three cycles. If the payment is rejected three times, the claim will be moved into a completed status.

### Example 2

### Requires Receipt First Time For Recurring Payment

In this example, a member logs into the system and submits a claim in the amount of $501 to his physician for a vision correction surgery. The system saves the physician information attached to this member. As this claim is greater than $500, the claim is placed in Pending status awaiting receipt. The member chooses to mail the receipt. When the receipt is received a customer service representative or CSR scans the document (or otherwise converts the document into an appropriate digital format) and attaches it to the claim. The claim moves into Approved status and awaits the next scheduled communication with the banking institution. The claim is sent to the banking institution for approval of payment. The banking institution approves her payment in the amount of $501 and wire transfers the funds to an account of the system administrator. The system administrator receives the approval file. A payment is attached to the claim. The system writes, and sends the $501 check. Later the member attempts to process another $501 for the same physician. The member selects the physician from the drop down selection menu. The form reloads with new options to elect this as a recurring claim. The member selects this box and submits the claim. A receipt is not requested and the claim is moved to approve status. The claim moves into approved status and awaits the next scheduled communication with the banking institution. The claim is sent or transmitted to the banking institution for approval of payment. The banking institution approves the payment in the amount of $501 and wire transfers the funds to an system administrator account. The system administrator receives an associated approval file. A payment is attached to the claim. The system writes, and sends the $501 check.

### Example 3

### Copay Recurring Payment Setup

In this example, a member logs into the system and sets up a recurring payment to her insurance carrier for COBRA premium payment. She elects a schedule wherein the payment is processed monthly for the next 12 months starting on that date. The schedule data is assessed nightly. That night, her first claim will be generated from the schedule data. The claim moves into approved status and awaits the next scheduled communication with the banking institution. The claim is sent to the banking institution for approval of payment. The banking institution approves her payment in the amount of the copay and wire transfers the funds to an account of the system administrator. The system administrator receives the associated approval file. A payment is attached to the claim. The system writes, and sends the copay check.

### Example

### Multiple Claims and Account Underfunded

In this example, a member logs into the system and submits a claim in the amount of $300 to her physician for a vision correction surgery. The system saves the physician information attached to this member. The claim moves into approved status and awaits the next scheduled communication with the banking institution. The member logs into the system and sets up a recurring payment in the amount of $100 to her insurance carrier for COBRA premium payment. She elects a schedule where the payment is processed monthly for the next 12 months starting on that date. The schedule data is assessed nightly. That night, her first claim will be generated from the schedule data. The claim moves into approved status and awaits the next scheduled communication with the banking institution. The claims are sent to the banking institution for approval of payment. The member only has $300 available in her account. The banking institution approves her payment in the amount of $300 and wire transfers the funds to an account of the system administrator. The system administrator receives the associated approval file. The system applies the payment starting with schedule copay amount. A payment is attached to the COBRA premium claim in the amount of $100. The remaining $200 is attached to the vision correction surgery claim. The claim moves into partially paid status. The system will continue to send a request for the remainder payment for three cycles. If the payment is rejected three times, the claim will be moved into completed status. The system writes, and sends the $300 check.

The foregoing description and accompanying drawings set forth the preferred embodiments of the Invention at the present time. Various modifications, additions and alternative designs will, of course, become apparent to those skilled in the art in light of the foregoing teachings without departing from the scope of the Invention. The scope of the Invention is indicated by the following claims rather than by the foregoing description. All changes and variations that fall within the meaning and range of equivalency of the claims are to be embraced within their scope.

What is claimed is:

1. A method of administering access to funds in at least one account for which disbursement of funds from the account requires meeting qualifications, comprising:
providing a computer interface via which at least one member can log onto a system;
determining if the member is eligible for disbursement of funds;
if the member is determined to be eligible, providing a computer interface via which the member can enter information associated with a claim for funds; and
applying rules saved in memory of the system to the information associated with the claim to determine if the claim meets the qualifications.

2. The method of claim 1 wherein the member can log onto the system via a computer network.

3. The method of claim 1 wherein the computer network comprises the internet.

4. The method of claim 1 wherein the account is a reimbursement account for retiree health benefits.

5. The method of claim 4 further comprising requesting further substantiation of the claim from the logged member.

6. The method of claim 5 wherein the further requested substantiation includes a request for documentation.

7. The method of claim 6 wherein the documentation comprises a receipt.

8. The method of claim 7 wherein a substantiation review is performed by a trained reviewer.

9. The method of claim 6 further comprising providing the member with instruction for transmission of substantiating documentation.

10. The method of claim 9 wherein the member can upload the documentation, fax the documentation or mail the documentation.

11. The method of claim 4 further comprising requesting a disbursement of funds from an account of the member maintained at an entity via the system.

12. The method of claim 11 further comprising the entity transferring funds into an account of an administrator of the system for disbursement to the member.

13. The method of claim 4 further comprising providing at least one type of accounting report via the system.

14. The method of claim 13 wherein a plurality of standard accounting reports are available.

15. The method of claims 13 wherein a customized accounting report can be generated.

16. The method of claim 4 wherein the rules are based at least in part upon section 213(d) of the Internal Revenue Code of the United States.

17. The method of claim 4 further comprising providing the member with choices of investment vehicles available from at least one entity in which funds can mature while awaiting disbursement.

18. The method of claim 17 wherein the system provides tools for managing funds in at least one account at the entity.

19. The method of claim 17 wherein the system provides account values.

20. The method of claim 4 further comprising mirroring or replicating data between two different storage locations.

21. The method of claim 20 wherein data is mirrored between memory of at least one investment or financial institution and memory of the system.

22. The method of claim 4 wherein eligibility is determined based at least in part upon data uploaded to memory of the system from another entity.

23. A method of administering a plan for post-employment benefits other than pension benefits for an employer participating in the plan, comprising:
providing at least one communication link between the employer and a computer controlled system comprising a processor system and a memory system;
providing at least one communication link between the computer controlled system and at least one financial intuition maintaining at least one banking account to which funds can be transferred and from which funds can be transferred for payment;
providing at least one communications link between the computer controlled system and at least one institution maintaining at least one investment account in which funds can be invested, the at least one account containing invested funds of a plurality of members, each member being a current employee or a former employee of the employer;
providing a computer interface via which a member can log on and communicate with the computer controlled system;
determining if the member is eligible for disbursement of funds from the investment account via the computer controlled system;
if the member is determined to be eligible, providing a computer interface via which the member can enter information associated with a claim for disbursement of funds; and
applying rules saved in the memory system of the computer controlled system to the information associated with the claim to determine if the claim meets the qualifications.

24. The method of claim 23 wherein the computer controlled system determines amounts of funds the employer is to transfer into various accounts and the employer is invoiced according to the determined amounts of funds.

25. The method of claim 24 wherein a plurality of investment accounts are provided, and the employer transfers funds to the at least one banking account in response to invoicing generated by the computer controlled system, the computer controlled system then transferring funds transferred by the employer into one or more of the investment accounts in a manner determined at least in part by instructions received from the plurality of members.

26. The method of claim 23 wherein the computer controlled system effects transfer of disbursement funds determined to meet the qualification from the at least one investment fund to the at least one banking fund, and then effects transfer of the disbursement funds determined to meet the qualification to the member.

27. A system for administering access to funds in at least one account for which disbursement of funds from the account requires meeting qualifications:
at least one administrator computer system;
at least one memory system in operative connection with the administrator computer system;
at least one communication portal in communicative connection with the administrator computer system to provide communication to and from the administrator computer system;
at least one list of members eligible members stored in the memory system;
at least one interface via which at least one of the members can log onto the administrator computer system upon providing the security information;
at least one interface via which the logged member can enter a claim for funds from the logged member's account and information associated with the claim; and
at least one set of rules stored in the memory system, the set of rules being applicable to the information associated with a claim submitted by the logged member to determine if the claim is qualified.
